(19) United States
(12) Patent Application Publication
(10) Pub. No.: US 2007/0291621 A1
(43) Pub. Date: Dec. 20, 2007

(54) Method of setting write conditions for optical recording media

(75) Inventors: Tsutomu Aoyama, Tokyo (JP); Tatsuya Kato, Tokyo (JP)

Correspondence Address: MATHEWS, SHEPHERD, MCKAY, & BRUNEAU, P.A., 29 THANET ROAD, SUITE 201, PRINCETON, NJ, 08540, US

(73) Assignee: TDK Corporation

(21) Appl. No.: 11/805,293

(22) Filed: May 23, 2007

(30) Foreign Application Priority Data
May 29, 2006 (JP) 2006-148527

(51) Int. Cl. G11B 7/00

(52) U.S. Cl. 369/116

(57) ABSTRACT

A method is provided to enable efficient optimization of write pulse waveforms using a trial writing region. To record information on an optical recording medium using a laser beam, the method includes: recording a specific pattern of multiple record marks on the trial writing region of the optical recording medium; decoding a read signal from the specific pattern using a PRML detection method; and tuning a write pulse waveform for forming the record marks based on the quality of decoded data determined by the PRML detection method.

### BACKGROUND OF THE INVENTION

1. Field of the Invention

The present invention relates to a method of setting write conditions for optical recording media, and in particular, to a method of determining an optimum recording condition by trial writing on an optical recording medium.

2. Description of the Related Art

Conventionally, various standard types of media such as CD-R/RWs or DVD-R/RWs have been widely used as optical recording media on which users can record information. In recent years, there has been growing demand for optical recording media of these types with higher storage capacities. To meet the demand, a new type of medium such as the Blu-ray Disc (BD) has also been suggested. According to an optical disc apparatus for Blu-ray Discs, the laser beam for reading or writing data thereon has a reduced beam spot diameter. More specifically, the laser beam is reduced in its wavelength λ and is condensed through an objective lens having an increased numerical aperture (NA). As a result, the Blu-ray Disc can have 25 GB of information stored on its information recording layer.

Typically, rewritable optical recording media on which information can be rewritten have a recording film made of a eutectic material. More specifically, the recording film is irradiated with a laser beam to be heated and then cooled down at an appropriately controlled rate, thereby forming amorphous and crystalline regions thereon as desired. The difference in reflectivity between the amorphous region and the crystalline region is used to record information. The laser requires recording conditions such as write power (Pw) of the highest energy, erase power (Pe) of intermediate energy, and bias power (Pb) of the lowest energy to be defined. Note that these recording conditions are typically pre-stored on the optical recording medium.

In order to improve recording accuracy, the read and write apparatus provides optimum power control (OPC). The OPC allows for analysis of the state of random data which have been written on a trial writing region of the optical recording medium, and thereby optimizes the levels of the write power (Pw) and the erase power (Pe) of the laser beam. Accordingly, the OPC can be used to optimize the laser power immediately before recording, taking into consideration service environment factors such as temperatures, the difference between individual lasers incorporated in each drive, the deterioration over time of the optical recording medium and the like, thereby allowing recording to be performed with improved accuracy.

However, an increase in recording rate with increased storage densities results in edge shifts occurring on record marks. The edge shift refers to a phenomenon, e.g., in which an increase in laser power from the bias power level to the write power level at the leading edge (front edge) of a record mark causes a shift in position of the front edge due to a time lag in the rising of the pulse. This edge shift would also occur at the trailing edge (rear edge) of the record mark. Additionally, when longer record marks such as those of 4T or 6T are formed using a plurality of write pulses, excessively high recording rates could fail to provide a sufficient length of time for cooling between write pulses. As a result, the leading edge pulse or the trailing edge pulse could cause recrystalization due to insufficient cooling. This recrystalization can also cause edge shifts. Accordingly, to realize high-speed recording, it is necessary to tune not only the laser power but also the laser pulse to a high degree. To this end, developments are currently being made in a variety of ways.

In Japanese Patent Laid-Open Publication No. 2006-40493, a technique was suggested in which all marks of even number lengths or all marks of odd number lengths are recorded as trial writing on a trial writing region for OPC, and the state of the recording is detected, thereby allowing a pulse to be optimally tuned for each record mark.

However, in Japanese Patent Laid-Open Publication No. 2006-40493, all types (all lengths) of record marks need to be recorded as trial writing. This increases the time required for trial writing as well as requiring a larger region for trial writing.

On the other hand, to further increase storage capacities, the storage density of the information recording layer must be further increased. An increase in storage density causes degradation in the quality of read signals, thereby making it difficult to determine bits by slice detection. In this context, employment of the PRML detection method for reading signals is contemplated. However, according to the PRML detection method, the read quality will vary with different contiguous multiple mark and space lengths. Thus, simply recording marks of all lengths as trial writing, as was conventionally done, would fail to provide sufficiently tuned pulse waveforms.

The present invention was developed in view of the aforementioned problems. It is therefore an object of the present invention to efficiently provide optimally tuned pulses by making use of a trial writing region, thereby allowing recording to be done with improved accuracy.

### SUMMARY OF THE INVENTION

As a result of intensive studies by the inventor, it has become apparent that write pulse waveforms can be efficiently tuned even for recording at high speeds and high densities.

To achieve the aforementioned object, a first aspect of the present invention is a method of setting write conditions for recording information on an optical recording medium using a laser beam. The method includes the steps of: recording a specific pattern of a plurality of record marks on a trial writing region of the optical recording medium; decoding a read signal from the recorded specific pattern using a PRML detection method; and tuning a write pulse waveform for forming the record marks based on a quality of decoded data determined by the PRML detection method.

To achieve the aforementioned object, a second aspect of the present invention is the method of setting write conditions according to the aforementioned aspect and may be configured such that the specific pattern regularly contains the record mark at a length of 2T or 3T, where T is a clock cycle during recording.

To achieve the aforementioned object, a third aspect of the present invention is the method of setting write conditions according to the aforementioned aspects and may be configured such that the specific pattern is an error-inducing pattern which mainly includes a specific error-prone record mark, and the write pulse waveform for forming the specific record mark is tuned based on the quality of decoded data determined by the PRML detection method.

To achieve the aforementioned object, a fourth aspect of the present invention is the method of setting write conditions according to the aforementioned aspects and may be configured to further include the steps of: prior to tuning the write pulse waveform, recording a power setting pattern on the trial writing region; and tuning a write power of the laser beam based on the quality of the read signal from the power setting pattern.

To achieve the aforementioned object, a fifth aspect of the present invention is the method of setting write conditions according to the aforementioned aspects and may be configured such that the write pulse waveform is tuned so long as the quality of the read signal from the power setting pattern does not satisfy a reference level.

To achieve the aforementioned object, a sixth aspect of the present invention is the method of setting write conditions according to the aforementioned aspects and may be configured such that a reference class of the PRML detection method is a constraint length 5 (1, 2, 2, 2, 1).

To achieve the aforementioned object, a seventh aspect of the present invention is the method of setting write conditions according to the aforementioned aspects and may be configured such that the laser beam has a wavelength set to between 400 and 410 nm, and the laser beam is condensed through an objective lens with a numerical aperture NA set at 0.70 to 0.90.

To achieve the aforementioned object, an eighth aspect of the present invention is the method of setting write conditions according to the aforementioned aspects and may be configured such that a read quality of the specific pattern is determined on the basis of an error rate.

To achieve the aforementioned object, a ninth aspect of the present invention is the method of setting write conditions according to the aforementioned aspects and may be configured such that the read quality of the specific pattern is determined on the basis of a SAM value.

To achieve the aforementioned object, a tenth aspect of the present invention is the method of setting write conditions according to the aforementioned aspects and may be configured such that the shortest mark having a length of 125 nm or less is recorded on the trial writing region of the information recording layer.

As describe above, the present invention advantageously allows efficient tuning of write pulse waveforms even during recording at such a high density that binary levels would not otherwise readily be discriminated by a slice level.

### BRIEF DESCRIPTION OF THE DRAWINGS

The above and other objects, features and advantages of the present invention will become apparent from the following description and appended claims, taken in conjunction with the accompanying drawings.

FIG. 1 is a block diagram illustrating a read and write apparatus for an optical recording medium according to an embodiment of the present invention;

FIGS. 2A and 2B illustrate the structure of the optical recording medium, FIG. 2A showing a perspective view, FIG. 2B showing an enlarged sectional view;

FIG. 3 is an enlarged perspective view illustrating how data is carried on an information recording layer of the optical recording medium;

FIG. 4 is a timing chart showing a pulse waveform in accordance with a write strategy by the read and write apparatus;

FIG. 5 is a flowchart showing the steps of setting write conditions by the read and write apparatus;

FIG. 6 is a graph showing write power for a power setting pattern provided by the read and write apparatus;

FIG. 7 is a timing chart showing an example of an error-inducing pattern provided by the read and write apparatus;

FIG. 8 is a timing chart showing an example of a pulse waveform for trial writing provided by the read and write apparatus;

FIG. 9 is a timing chart showing another example of a specific pattern provided by the read and write apparatus; and

FIG. 10 is a timing chart showing another technique for trial writing provided by the read and write apparatus.

### DETAILED DESCRIPTION OF THE PREFERRED EMBODIMENTS

Now, the present invention will be described below in more detail with reference to the accompanying drawings in accordance with the embodiments.

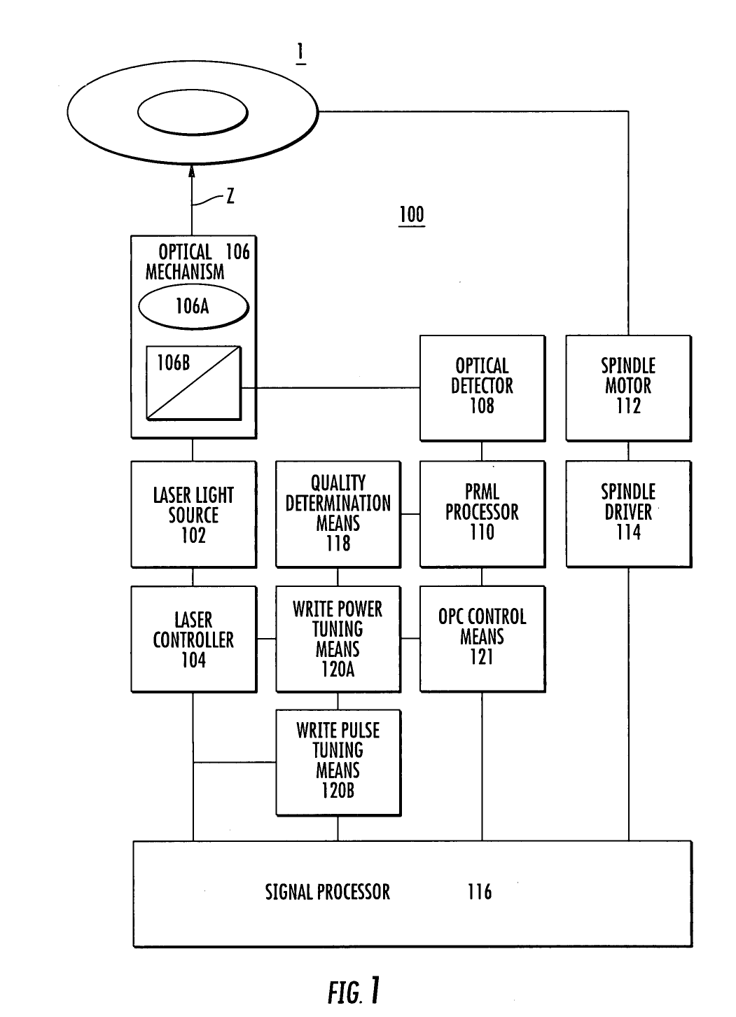

FIG. 1 shows a read and write apparatus 100 that implements a method of setting write conditions according to an embodiment of the present invention. The read and write apparatus 100 includes: a laser light source 102 for generating a laser beam Z used for read and write operations; a laser controller 104 for controlling the laser light source 102; an optical mechanism 106 for directing the laser beam Z onto an optical recording medium 1; an optical detector 108 for detecting a reflected beam of the laser beam Z during readout; a PRML processor 110 for decoding the information detected by the optical detector 108 according to the PRML detection method; a spindle motor 112 for rotating the optical recording medium 1; a spindle driver 114 for rotatably controlling the spindle motor 112; a signal processor 116 for exchanging decoded read data with a CPU (central processing unit, not shown); quality determination means 118 for evaluating the quality of read data based on the information provided through the decoding by the PRML processor 110; write power tuning means 120A for tuning the write power controlled by the laser controller 104 based on the result provided by the quality determination means; write pulse tuning means 120B for tuning the waveform of the write pulse controlled by the laser controller 104; and OPC control means 121 for recording by trial writing on the trial writing region of the optical recording medium 1.

The laser light source 102 is a semiconductor laser and controlled by the laser controller 104 to emit the laser beam Z. The optical mechanism 106, which includes an objective lens 106A and a half mirror 106B, is capable of focusing the laser beam Z on the information recording layer as appropriate. Note that the half mirror 106B can receive a reflected beam from the information recording layer and direct it to the optical detector 108. The optical detector 108, which is a photodetector, can receive the reflected beam of the laser beam Z and convert it into an electrical signal as a read signal. This read signal is delivered to the PRML processor 110. The PRML processor 110 can decode the read signal and then deliver the resulting binary digital signal to the signal processor 116 as read data.

Furthermore, in the read and write apparatus 100, the laser beam Z has a wavelength set at 400 to 410 nm. Additionally, the objective lens 106A of the optical mechanism 106 has a numerical aperture NA set at 0.70 to 0.90. To initiate reading of information on the optical recording medium 1, the laser light source 102 emits the laser beam Z with initial read power, so that the information recording layer of the optical recording medium 1 is irradiated with the laser beam Z. The laser beam Z is reflected off the information recording layer to be captured by the optical mechanism 106, and then converted into an electrical signal in the optical detector 108. The resulting electrical signal is converted into a digital signal through the PRML processor 110 and the signal processor 116, and then supplied to the CPU.

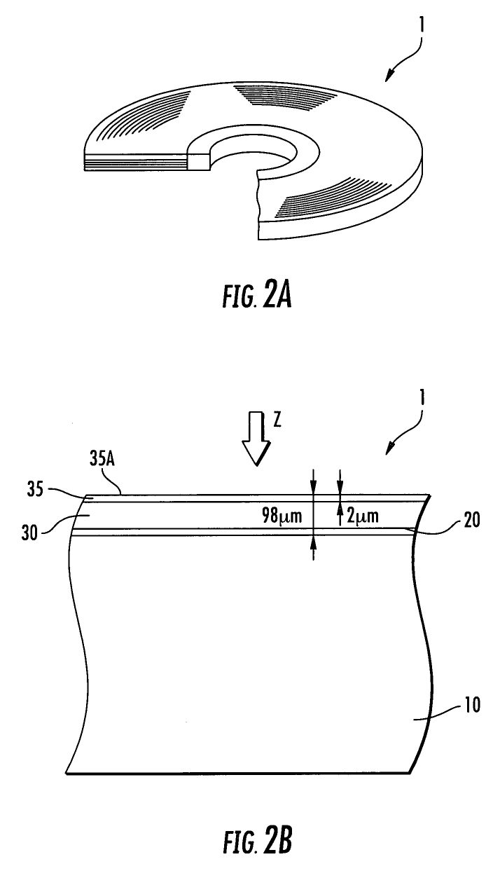

A description will now be provided regarding the optical recording medium 1 that is used for reading operations by the read and write apparatus 100. As shown in FIG. 2A, the optical recording medium 1 or a disc-shaped medium has an outer diameter of approximately 120 mm and a thickness of approximately 1.2 mm. As shown in the enlarged view of FIG. 2B, the optical recording medium 1 has a substrate 10, on which an information recording layer 20, a cover layer 30, and a hard coat layer 35 are stacked in that order.

The cover layer 30 and the hard coat layer 35, which are optically transparent, are adapted to transmit the laser beam Z that is externally incident thereon. Accordingly, the laser beam Z incident upon a light incident surface 35A passes through the hard coat layer 35 and the cover layer 30 in that order to reach the information recording layer 20 for reading and writing of information on the information recording layer 20.

The substrate 10 is a disc-shaped member which has a thickness of approximately 1.1 mm and is formed from any of various materials such as glass, ceramics, and resin. In the present embodiment, it is made of polycarbonate resin. Note that other than the polycarbonate resin, the resin employed may be olefin resin, acrylic resin, epoxy resin, polystyrene resin, polyethylene resin, polypropylene resin, silicone resin, fluorine-based resin, ABS resin, or urethane resin. Among these resins, the polycarbonate resin and the olefin resin are preferable in terms of ease of machinability and formability. Additionally, on the information recording layer side of the substrate 10, there are formed arrays of grooves, lands, or pits depending on its application.

The cover layer 30 may be formed from various materials, but as already mentioned above, it has to be formed from an optically transparent material in order to transmit the laser beam Z. For example, it is also preferable to use UV curable acrylic resin. The optical recording medium 1 is also configured such that the cover layer 30 has a thickness set at 98 μm and the hard coat layer 35 has a thickness set at 2 μm. Accordingly, the distance from the light incident surface 35A to the information recording layer 20 is approximately 100 μm. The optical recording medium 1 conforms to the specifications of the current Blu-ray Disc except for its storage capacity (currently 25 GB in this application).

The information recording layer 20 retains data thereon, and the manner in which the data is retained is of a recordable type for allowing the user to write data thereon. There are two recordable types available: a write-once type which does not allow data to be written again on an area on which data has been once written, and a rewritable type which allows data written on an area to be erased therefrom and another piece of data to be written again thereon. This embodiment has employed the rewritable type.

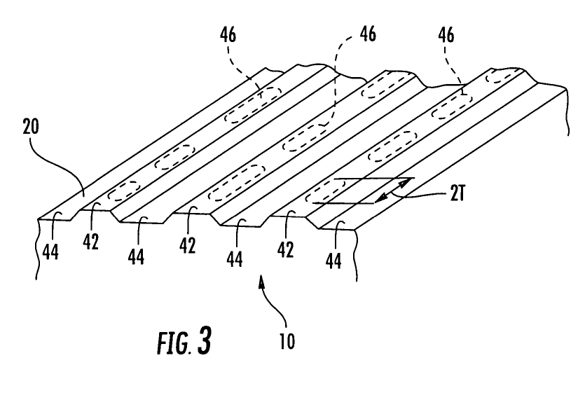

Furthermore, as shown in FIG. 3, the information recording layer 20 has a spiral groove 42 or land 44 formed on the surface of the substrate 10. The information recording layer 20 has recording film on which a record mark 46 can be formed with the energy of the laser beam Z. The groove 42 serves as a guide track for the laser beam Z during recording of data. As a result, the laser beam Z travels along the groove 42. Modulating the energy intensity (power) of the laser beam Z would allow the record mark 46 to be formed on the information recording layer 20 on top of the groove 42. Since this embodiment employs the rewritable type to retain data, the record mark 46 is formed reversibly, and thus data can be erased and written again. Note that such in the present embodiment the record mark 46 is formed on the groove 42; however, it can also be formed on the land 44. It is also possible to form the record mark 46 both on the groove 42 and the land 44.

The storage capacity of the information recording layer 20 is determined by the combination of the size of the recording region (area) and the storage density. The recording region is physically limited. Thus, in the present embodiment, as shown in FIG. 3, the linear density of each record mark 46 is increased, thereby increasing the storage density. An increase in the linear density means a decrease in the spiral length of a single record mark 46. In the present embodiment, the shortest record mark length (and the shortest space length) is 2T, where T is the clock cycle. Accordingly, the clock cycle T may be reduced to further shorten, in the spiral direction, the shortest mark length 2T of the record mark 46 formed on the information recording layer 20, resulting in the storage capacity being increased. In the present embodiment, the shortest mark length 2T is set at 124.3 nm to 106.5 nm, more specifically, at 111.9 nm. Note that the shortest mark length 2T being 124.3 nm makes it possible to record 30 GB of information on the information recording layer 20. Similarly, the shortest mark length 2T being 106.5 nm would allow 35 GB of information to be recorded on the information recording layer 20.

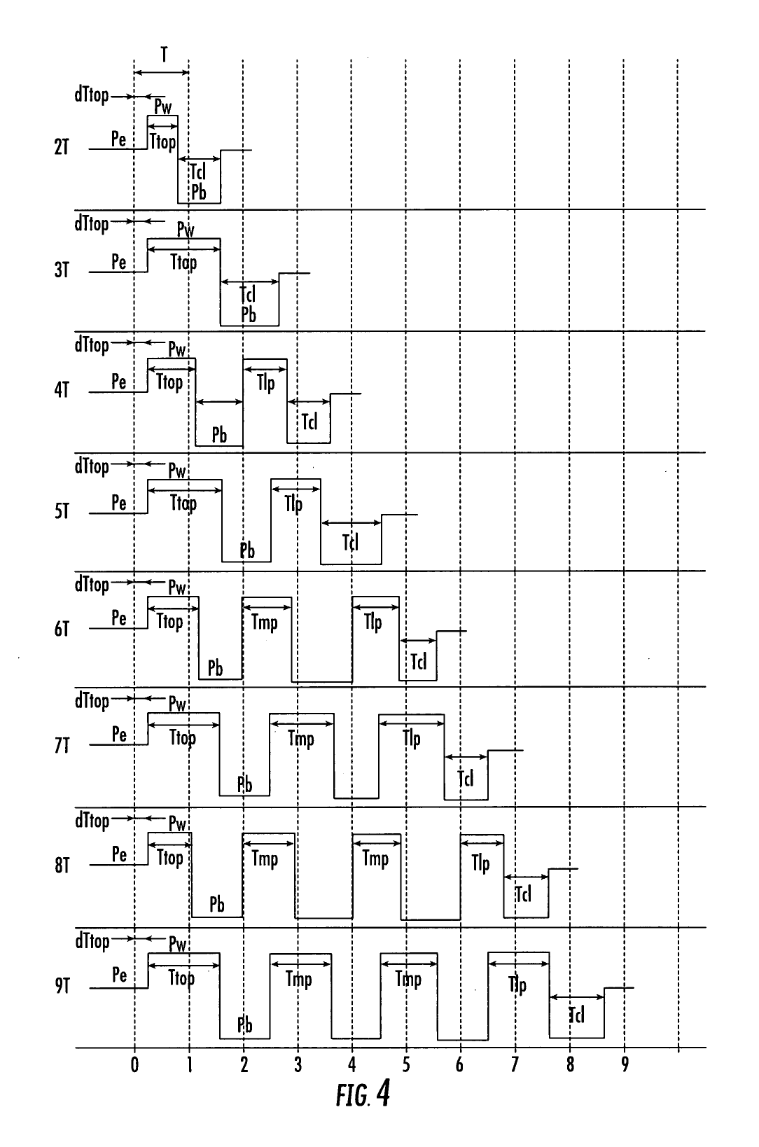

This embodiment has employed a 2T cycle write strategy for recording information on the information recording layer 20. For example, suppose that the shortest record mark length is 2T and the longest record mark length is 9T. In this case, as shown in FIG. 4, a 2T mark and a 3T mark are recorded with one rectangular pulse waveform (with only a leading edge pulse Ttop); a 4T mark and a 5T mark are recorded with two rectangular pulse waveforms (with the leading edge pulse Ttop and a trailing edge pulse Tlp); and a 6T mark and a 7T mark are recorded with three rectangular pulse waveforms (the leading edge pulse Ttop, an intermediate pulse Tmp, and the trailing edge pulse Tlp). Furthermore, an 8T mark and a 9T mark are recorded with four rectangular pulse waveforms (the leading edge pulse Ttop, two intermediate pulses Tmp, and the trailing edge pulse Tlp). Additionally, all of these write pulses are set at write power Pw. The rising timing of the leading edge pulse Ttop is delayed by dTtop from the regular timing of the clock cycle so that the edge at leading edge side of a record mark is not excessively heated. The region of the record mark other than these rectangular pulses is filled with a cooling pulse Tcl set at a bias power Pb. Note that the space regions before and after the record mark are set at an erase power Pe.

A description will now be provided regarding the PRML (Partial Response Maximum Likelihood) detection method in the PRML processor 110. The PRML detection method is intended to estimate binary data recorded on the information recording layer 20 based on an analog electrical signal detected by the optical detector 108. The PRML detection method requires the selection of the appropriate reference class of a PR (Partial Response) in consideration of read characteristics. In the present embodiment, a constraint length 5 (1, 2, 2, 2, 1) is selected as the PR reference class. The constraint length 5 (1, 2, 2, 2, 1) means that the read response to a symbol bit “1 ” restricts 5 bits, and the waveform of the read response can be represented by a series of “12221”. The read response to various types of actually stored symbol bits is presumably determined by the convolution of the series “12221”. For example, the response to a symbol bit series 00100000 is 00122210. Likewise, the response to a symbol bit series 00010000 is 00012221. Accordingly, the response to a symbol bit series 00110000 is determined to be 00134431 by the convolution of the aforementioned two responses. The response to a symbol bit series 001110000 is 001356531. Accordingly, in the convolution, the slice level is not determined for each bit, but the effects between neighboring bits are taken into account to decode read signals. That is, reading is made possible even if each bit cannot be individually detected.

Note that the response of the PR class is taken to be the ideal. In this sense, the aforementioned response is referred to as an ideal response. As a matter of course, an actual response contains noise and is thus shifted from the ideal response. Accordingly, an ideal response that minimizes the difference (distance) between an actual response containing noise and the pre-assumed ideal response is selected through a comparison therebetween and employed as a decoded signal. This process is referred to as the ML (Maximum Likelihood) detection. Suppose that a recorded symbol bit “1 ” is read as a read signal that approximates “12221”. In this case, the PRML detection of the constraint length 5 (1, 2, 2, 2, 1) may be made so as to read the signal in the step from the read signal through the ideal response “12221” to the decoded signal “1”.

In the ML detection, the difference between the ideal response and an actual response is derived using the Euclidean distance. For example, the Euclidean distance E between the actual read response series A (=A0, A1, . . . , An) and the ideal response series B (=B0, B1, . . . , Bn) is defined as E=√{Σ(Ai−Bi)²}. Accordingly, comparisons are made for ranking between the actual response and multiple pre-assumed ideal responses using the Euclidean distance, thereby selecting the ideal response (maximum likelihood ideal response) that minimizes the Euclidean distance for decoding.

A description will now be provided regarding the quality determination means 118, the write power tuning means 120A, the write pulse tuning means 120B, and the OPC control means 121. The quality determination means 118 receives data in the decoding step of the PRML detection method in the PRML processor 110, and then makes use of the data to detect an error rate or a SAM (Sequenced Amplitude Margin) value, thereby evaluating the quality of the read data. Here, the SAM value refers to the difference between the Euclidean distance of the maximum likelihood ideal response and the Euclidean distance of the subsequent second ranked ideal response. Accordingly, the quality determination means 118 determines the quality of read data depending on whether the result obtained by an evaluation using an error rate or a SAM value satisfies a certain criterion or whether an uncorrectable error has occurred. The result of this determination is provided to the OPC control means 121 etc. Note that an error rate and a SAM value are given as an example of a quality level value; however, without being limited thereto, the present invention may also determine the signal quality using another technique.

The write power tuning means 120A provides the laser controller 104 with settings for the write power Pw, the erase power Pe, and the bias power Pb. The write pulse tuning means 120B provides the write pulse waveforms from the laser controller 104 with a setting for each record mark. Note that the specific values for these recording conditions are determined by the OPC control means 121, which is discussed below.

Before writing actual data, the OPC control means 121 records data as trial writing on the trial writing region of the optical recording medium 1. More specifically, the OPC control means 121 first records a power setting pattern containing simple data made up of a repetition of specific data or random data on the trial writing region, while changing the laser power in stages. Thereafter, the recorded power setting pattern is read, so that the quality determination means 118 determines the quality of the read signal. Using the result of the determination, the OPC control means 121 selects the write power that minimizes the error rate or the SAM value, and then directs the write power tuning means 120A to employ the resulting power as the actual write power Pw.

Furthermore, based on the re-tuned write power Pw, the OPC control means 121 records the specific pattern on the trial writing region. Note that the specific pattern refers not to random data that varies from time to time but to a predefined pattern. The present embodiment uses an error-inducing pattern as the specific pattern. The OPC control means 121 records the error-inducing pattern while varying the pulse waveform in stages. Thereafter, the error-inducing pattern is read, so that the quality determination means 118 determines the signal quality. The OPC control means 121 selects the pulse waveform that minimizes the error rate or the SAM value, and then directs the write pulse tuning means 120B to employ the resulting waveform as the actual write pulse waveform. The control provided by the above means can optimize the write power and the write pulse in this manner. Note that the error-inducing pattern refers to such a pattern that mainly contains a specific error-prone record mark among a group of record marks. The present embodiment utilizes such an error-inducing pattern that mainly contains the 2T mark or the 3T mark as the specific record mark, either of which is considered to be prone to error in the PRML signal processing. Accordingly, pulse waveforms may be tuned only in relation to the aforementioned specific record mark (the 2T mark or the 3T mark).

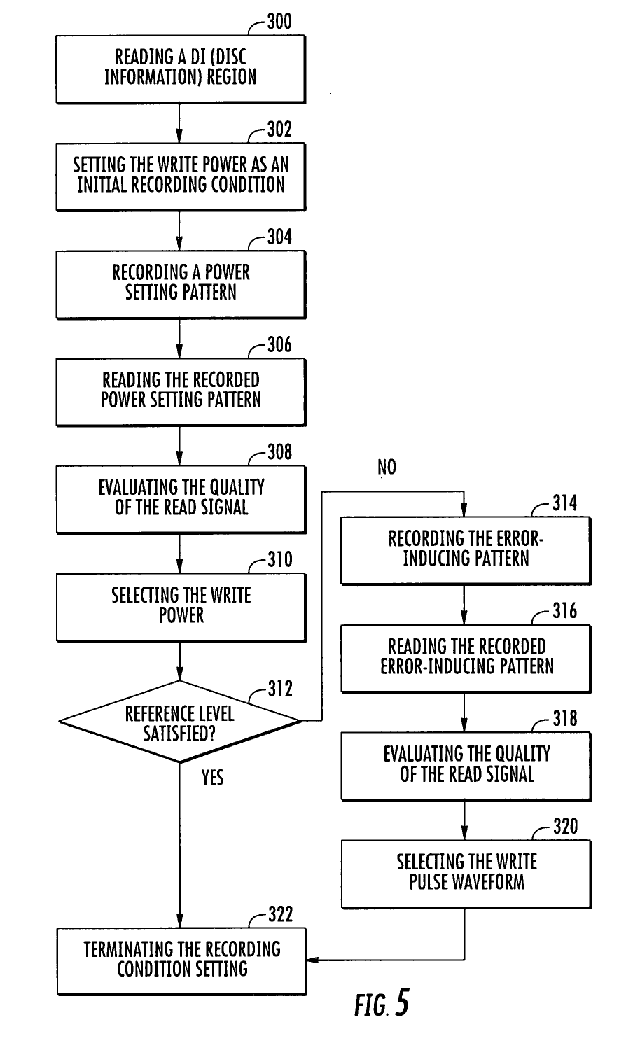

Now, the method of setting write conditions that is provided by the read and write apparatus 100 will be described in more detail with reference to the flowchart of FIG. 5 etc.

In step 300, the OPC control means 121 first reads a DI (Disc Information) region of the optical recording medium 1, thereby obtaining information regarding the basic characteristics of the optical recording medium 1. The DI region has stored on it the type of the medium (e.g., the write-once type or the rewritable type), recording speed (e.g., 1× or 2×), and the write strategy as well as the recommended write power P_{K} of the laser beam. Accordingly, there commended write power P_{K} is set as an initial recording condition (step 302).

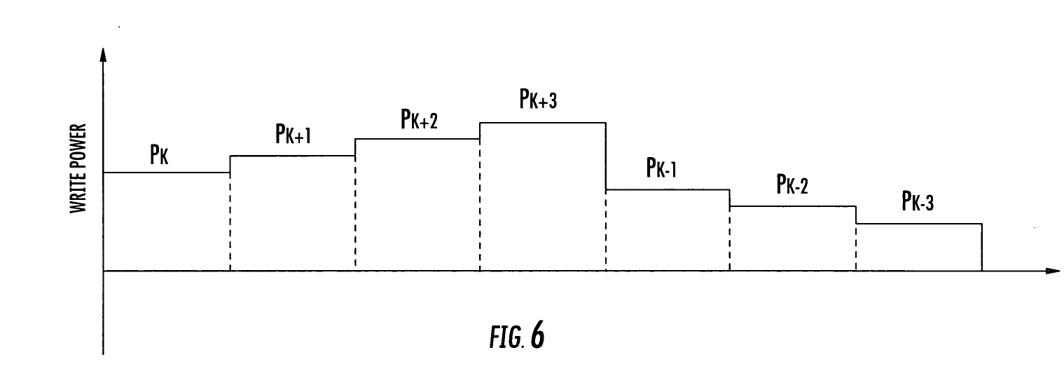

Then, in step 304, a power setting pattern (a random pattern in the present embodiment) is recorded on the trial writing region of the optical recording medium 1. In this case, as shown in FIG. 6, the power is varied in multiple stages to be greater than and less than the recommended write power P_{K} (i.e., P_{K+1}, P_{K+2}, P_{K+3}, P_{K-1}, P_{K-2}, and P_{K-3}), and then each of these powers is used to actually record the power setting pattern. Thereafter, in step 306, the recorded power setting pattern is read using the PRML processor 110, and in step 308 the quality determination means 118 evaluates the quality of the read signal using the error rate or the SAM value. Based on the result of the evaluation, the OPC control means 121 selects the write power at which the best quality recording was carried out, and then directs the write power tuning means 120A to employ the resulting power as the actual write power Pw (step 310).

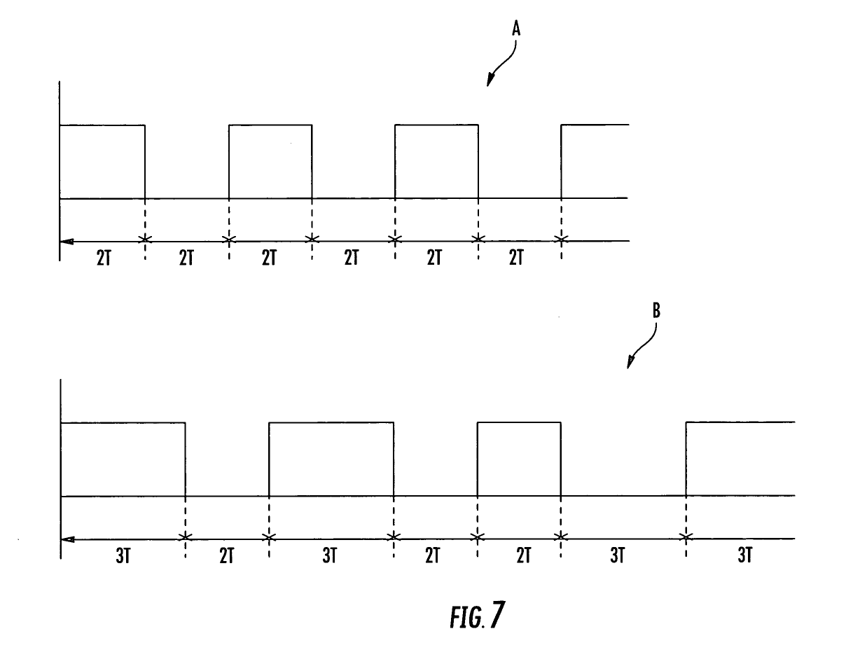

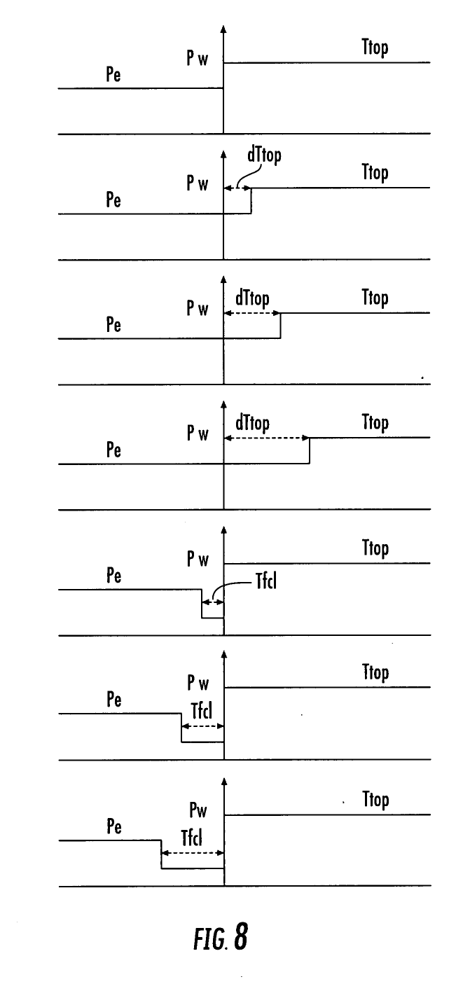

Then, in step 312, it is determined whether the quality of the read signal from the power setting pattern that was recorded at the selected write power Pw satisfies the reference level at which data can be actually recorded. If the reference level is satisfied, it is determined that the initial setting of the recording condition has been completed, and the recording condition setting is terminated (step 322). On the other hand, if the reference level is not satisfied, it is determined that further tuning is required for the write pulse waveform, and thus the control proceeds to step 314, where the error-inducing pattern is recorded on the trial writing region. As shown in FIG. 7, the error-inducing patterns employed here are a 2T error-inducing pattern A having the 2T mark and 2T space frequently repeated, and a 3T error-inducing pattern B having a combination of the 3T mark and a mark or space having another length. That is, the used pattern includes a regular repetition of the 2T mark or the 3T mark. As shown in FIG. 8, the error-inducing pattern is recorded while the waveform of the leading edge pulse Ttop for the 2T mark or the 3T mark is varied in multiple stages. More specifically, the recording initiation timing dTtop of the write pulse for the 2T mark or the 3T mark (the rising timing of the leading edge pulse Ttop) is delayed from the regular timing of the clock cycle T in multiple stages. Additionally, prior to an irradiation with the leading edge pulse Ttop, a cooling pulse Tfcl at a low power for avoiding edge shifts is inserted at multiple lengths. Under these various conditions, recording is carried out as trial writing.

Thereafter, instep 316, the error-inducing pattern is read through the PRML signal processing, and then in step 318, the quality of the resulting read signal is evaluated. As a result, in step 320, the write pulse waveform that provides the best signal quality is selected from among multiple types of pulse waveforms as shown in FIG. 8, and then the recording condition setting is terminated (step 322). Subsequently, the process proceeds to recording of actual data.

According to the read and write apparatus 100, the condition of the write pulse is set each time information is recorded on the optical recording medium 1, thereby making it possible to carry out recording with improved accuracy. In particular, a specific pattern is actively recorded on the trial writing region of the optical recording medium 1 and read by the PRML detection method, thereby enabling efficient tuning of pulses. Reading by the PRML detection method is based on the premise that the read waveform is represented by the convolution of reference classes of PR. Accordingly, the read waveform and the quality of read signals would vary depending not only on the length of each record mark but also on the combination of multiple record marks and spaces. However, trial writing of all the permutational combinations of record mark lengths is impractical because of the huge number of possible combined patterns. In this respect, as is done with the read and write apparatus 100, only an error-inducing pattern which is prone to error during recording may be recorded as trial writing, thereby allowing pulses to be tuned in a short time even using an evaluation technique with a PRML detection method.

Furthermore, even when recording is carried out at high densities which may cause difficulty in making a bit (binary) determination with respect to a slice level, the PRML detection method can be employed to evaluate signal qualities, thereby enabling tuning of write pulses. More specifically, the laser beam has a wavelength of 400 to 410 nm, the objective lens for condensing the laser beam has a numerical aperture NA of 0.70 to 0.90, and the shortest mark or the 2T mark has a length of 125 nm or less. Even when recording is conducted at a very high density under these conditions, it is possible to record with significantly improved accuracy.

In particular, the PRML detection method tends to frequently induce errors when employed with a pattern A having a continual occurrence of the 2T marks or a pattern B having a combination of the 3T mark and a record mark of another length. Accordingly, if the patterns A and B can be recorded with a sufficient accuracy, it can be assured that other recording patterns will also be recorded with a sufficient accuracy. As a result, pulse waveforms can be efficiently tuned. Errors caused by the 2T and 3T marks will occur most frequently when the reference class of the PRML detection method has the constraint length 5.

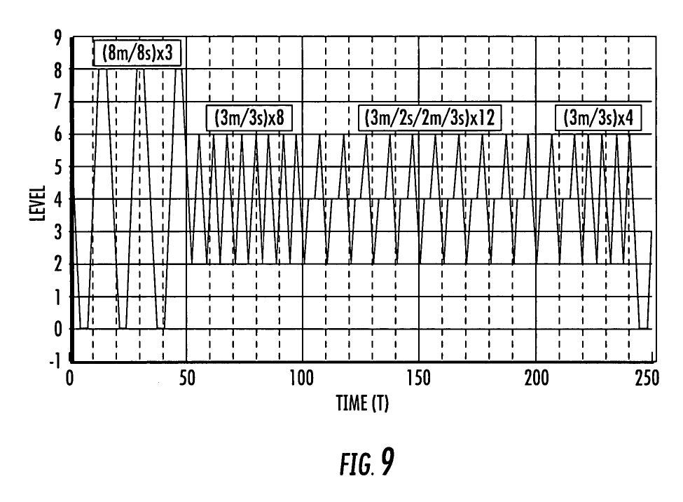

Note that in the present embodiment, the patterns A and B of FIG. 7 have been shown as an example of the error-inducing pattern; however, the present invention is not limited thereto in terms of the pattern and the number of repetitions. For example, as shown in the read waveform of FIG. 9, it is also possible to use such a specific pattern in which the 8T mark (8m) and an 8T space (8s) are repeated three times; then the 3T mark (3m) and 3T space (3s) are repeated eight times; thereafter a set of the 3T mark (3m), 2T space (2s), the 2T mark (2m), and a 3T space (3s) is repeated twelve times; and finally the 3T mark (3m) and 3T space (3s) are repeated four times. In this way, a pattern having a regular inclusion of the 3T mark and the 2T mark can be used, thereby allowing for tuning pulse waveforms with high efficiency.

Additionally, the read and write apparatus 100 is adapted such that prior to write pulse tuning, the write power is tuned by recording of the power setting pattern as trial writing. Conversely, the write pulse is not tuned when sufficient recording accuracy at the stage of write power tuning has not yet been achieved. This helps to avoid unnecessary pulse tuning, thereby reducing the time required for setting of recording conditions.

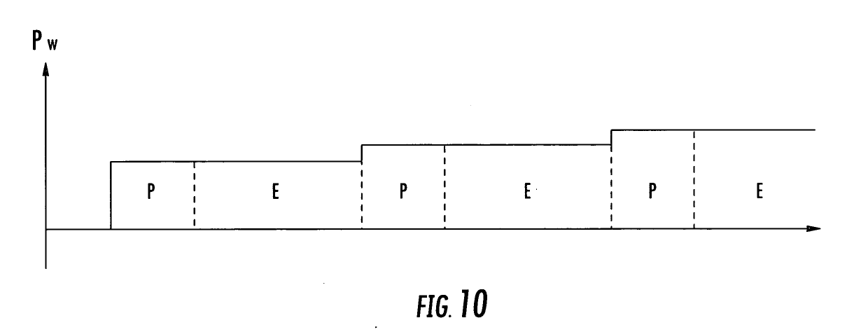

Note that in the present embodiment, only such a case has been described in which the error-inducing pattern is recorded as trial writing after the write power has been completely tuned by the power tuning pattern being recorded as trial writing; however, the present invention is not limited thereto. For example, as shown in FIG. 10, a power tuning pattern P and the error-inducing pattern E can be recorded at the same time as trial writing. In this case, at all the multiple write powers, multiple types of pulse waveforms are used to record an error-inducing pattern as trial writing. This makes it possible to concurrently tune the write power and the write pulse with one-time trial writing.

In the foregoing, this embodiment has been described with reference to only such a case where the optical recording medium has a single information recording layer; however, the present invention is not limited thereto, but is also applicable to a multi-layered structure. In the case of the multi-layered structure, trial writing may be conducted on each of the information recording layers.

It is to be understood that the method of setting write conditions according to the present invention is not limited to the aforementioned embodiments, but various modifications may be made thereto without deviating from the scope and spirit of the present invention.

According to the present invention, optimum recording conditions can be set and recording accuracy can be improved even when recording is conducted on an optical recording medium which has an increased storage capacity or storage density.

The entire disclosure of Japanese Patent Application No. 2006-148527 filed on May 29, 2006 including specification, claims, drawings, and summary are incorporated herein by reference in its entirety.

What is claimed is:

1. A method of setting a write condition for recording information on an optical recording medium using a laser beam, the method comprising the steps of:
recording a specific pattern of a plurality of record marks on a trial writing region of the optical recording medium;
decoding a read signal from the recorded specific pattern using a PRML detection method; and
tuning a write pulse waveform for forming the record marks based on a quality of decoded data determined by the PRML detection method.

2. The method of setting a write condition according to claim 1, wherein the specific pattern regularly contains the record mark at a length of 2T or 3T, where T is a clock cycle during recording.

3. The method of setting a write condition according to claim 1, wherein
the specific pattern is an error-inducing pattern which mainly includes a specific error-prone record mark, and
the write pulse waveform for forming the specific error-prone record mark is tuned based on the quality of decoded data determined by the PRML detection method.

4. The method of setting a write condition according to claim 1, further comprising the steps of, prior to the step of tuning the write pulse waveform:
recording a power setting pattern on the trial writing region; and
tuning a write power of the laser beam based on the quality of the read signal from the power setting pattern.

5. The method of setting a write condition according to claim 1, further comprising the steps of, prior to the step of tuning the write pulse waveform:
recording a power setting pattern on the trial writing region; and
tuning a write power of the laser beam based on the quality of the read signal from the power setting pattern, and wherein the write pulse waveform is tuned so long as the quality of the read signal from the power setting pattern does not satisfy a reference level.

6. The method of setting a write condition according to any of claims 1, wherein a reference class of the PRML detection method has a constraint length 5 (1, 2, 2, 2, 1).

7. The method of setting a write condition according to any of claims 1, wherein the laser beam has a wavelength set to between 400 and 410 nm, and the laser beam is condensed through an objective lens with a numerical aperture NA set at 0.70 to 0.90.

8. The method of setting a write condition according to any of claims 1, wherein a read quality of the specific pattern is determined on the basis of an error rate.

9. The method of setting a write condition according to any of claims 1, wherein the read quality of the specific pattern is determined on the basis of a SAM value.

10. The method of setting a write condition according to any of claims 1, wherein the shortest mark having a length of 125 nm or less is recorded on the trial writing region of the information recording layer.

11. A method of setting a write condition for recording information on an optical recording medium using a laser beam, the method comprising the steps of:
recording a power setting pattern on the trial writing region;
tuning a write power of the laser beam based on the quality of the read signal from the power setting pattern;
recording a specific pattern of a plurality of record marks on a trial writing region of the optical recording medium;
decoding a read signal from the recorded specific pattern using a PRML detection method; and
tuning a write pulse waveform for forming the record marks based on a quality of decoded data determined by the PRML detection method, and wherein
the specific pattern regularly contains the record mark at a length of 2T or 3T, where T is a clock cycle during recording.

12. The method of setting a write condition according to claim 11, wherein the write pulse waveform is tuned so long as the quality of the read signal from the power setting pattern does not satisfy a reference level.

13. The method of setting a write condition according to any of claims 11, wherein a reference class of the PRML detection method has a constraint length 5 (1, 2, 2, 2, 1).

14. The method of setting a write condition according to any of claims 11, wherein the laser beam has a wavelength set to between 400 and 410 nm, and the laser beam is condensed through an objective lens with a numerical aperture NA set at 0.70 to 0.90.

15. The method of setting a write condition according to any of claims 11, wherein a read quality of the specific pattern is determined on the basis of an error rate.

16. A method of setting a write condition for recording information on an optical recording medium using a laser beam, the method comprising the steps of:
recording a power setting pattern on the trial writing region;
tuning a write power of the laser beam based on the quality of the read signal from the power setting pattern;
recording a specific pattern of a plurality of record marks on a trial writing region of the optical recording medium;
decoding a read signal from the recorded specific pattern using a PRML detection method; and
tuning a write pulse waveform for forming the record marks based on a quality of decoded data determined by the PRML detection method, and wherein
the specific pattern is an error-inducing pattern which mainly includes a specific error-prone record mark, and
the write pulse waveform for forming the specific error-prone record mark is tuned based on the quality of decoded data determined by the PRML detection method.

17. The method of setting a write condition according to claim 16, wherein the write pulse waveform is tuned so long as the quality of the read signal from the power setting pattern does not satisfy a reference level.

18. The method of setting a write condition according to any of claims 16, wherein a reference class of the PRML detection method has a constraint length 5 (1, 2, 2, 2, 1).

19. The method of setting a write condition according to any of claims 16, wherein the laser beam has a wavelength set to between 400 and 410 nm, and the laser beam is condensed through an objective lens with a numerical aperture NA set at 0.70 to 0.90.

20. The method of setting a write condition according to any of claims 16, wherein a read quality of the specific pattern is determined on the basis of an error rate.
